(19) United States
(12) Patent Application Publication
(10) Pub. No.: US 2019/0250660 A1
(43) Pub. Date: Aug. 15, 2019

(54) INFORMATION PROCESSING DEVICE, INFORMATION PROCESSING DEVICE CONTROL METHOD, AND RECORDING MEDIUM

(71) Applicant: SHARP KABUSHIKI KAISHA, Sakai City, Osaka (JP)

(72) Inventors: HIROKI TANABE, Sakai City (JP); HIDENORI KUWAJIMA, Sakai City (JP)

(21) Appl. No.: 16/343,836

(22) PCT Filed: Aug. 23, 2017
(86) PCT No.: PCT/JP2017/030187

§ 371 Date: Apr. 22, 2019

(30) Foreign Application Priority Data
Nov. 2, 2016 (JP) 2016-215617

(51) Int. Cl. G06F 1/12; H04W 52/02; G06F 1/08

(52) U.S. Cl. CPC G06F 1/12; H04W 52/029; G06F 1/08; H04W 52/0229

(57) ABSTRACT

It is an object of the present invention to carry out communication processing without impairing the comfort of a user. A smartphone (1) includes a frequency defining section (102) configured to, in a case where a current value of communication throughput is greater than a reference value or in a case where an expected value of the communication throughput is equal to or greater than a reference value, define an operating frequency of a CPU (12) as an operating frequency greater than an operating frequency brought into correspondence with a current processing load in first frequency setting information.

### TECHNICAL FIELD

An aspect of the present invention relates to an information processing device and the like each having a CPU which is capable of carrying out processing for communication with an external device.

### BACKGROUND ART

In recent years, a technique for controlling the operating frequency of a central processing unit (CPU) has been developed. Patent Literature 1 discloses the technique of changing the operating frequency of a CPU, determining whether a change has occurred in traffic of a radio channel after the change of the operating frequency, and determining the operating frequency of the CPU based on a result of the determination. With such a technique, the invention described in Patent Literature 1 achieves reduction in power consumption without decreasing communication throughput.

### CITATION LIST

### Patent Literature

[Patent Literature 1] Japanese Patent Application Publication, Tokukai, No. 2014-63398 (Publication Date: Apr. 10, 2014)
[Patent Literature 2] Japanese Patent Application Publication, Tokukai, No. 2010-39543 (Publication Date: Feb. 18, 2010)

### SUMMARY OF INVENTION

### Technical Problem

In the invention described in Patent Literature 1, when the load of the CPU is greater than a threshold value, the above-described determination of the operating frequency of the CPU is carried out. In other words, in the invention described in Patent Literature 1, when the load of the CPU is equal to or less than the threshold value, the above-described determination of the operating frequency of the CPU is not carried out. Thus, in the invention described in Patent Literature 1, when an event in which the load of the CPU is abruptly increased or the like event occurs, there is a possibility that it is impossible to immediately ensure the processing capacity of the CPU for carrying out communication processing.

Thus, in the invention described in Patent Literature 1, a situation can occur where the communication throughput is decreased. As a result, in the invention described in Patent Literature 1, a longer time can be required for communication processing, or/and an application can run slowly. Therefore, the invention described in Patent Literature 1 can impair the comfort of a user.

An aspect of the present invention has been attained in view of the above problems, and it is an object of the present invention to realize an information processing device and the like each carrying out communication processing without impairing the comfort of a user.

### Solution to Problem

In order to solve the above problem, an information processing device in accordance with an aspect of the present invention is an information processing device having a CPU which is capable of carrying out processing for communication with an external device, the information processing device including: a storage section configured to store first frequency setting information which is referred to at start-up of the information processing device, the first frequency setting information containing a processing load of the CPU and an operating frequency of the CPU both of which are brought into correspondence with each other; and a defining section configured to, in a case where a current value of communication throughput is equal to or greater than a first reference value or in a case where an expected value of the communication throughput is equal to or greater than a second reference value, define an operating frequency of the CPU as a value equal to or greater than an operating frequency brought into correspondence with a current processing load in the first frequency setting information.

Further, in order to solve the above problem, an information processing device in accordance with an aspect of the present invention is an information processing device having a CPU which is capable of carrying out processing for communication with an external device, the information processing device including: a storage section configured to store first frequency setting information which is referred to at start-up of the information processing device, the first frequency setting information containing a processing load of the CPU and an operating frequency of the CPU both of which are brought into correspondence with each other; and a defining section configured to, in a case where the information processing device is in communication, define an operating frequency of the CPU as a value equal to or greater than an operating frequency brought into correspondence with a current processing load in the first frequency setting information.

Still further, in order to solve the above problem, a method of controlling an information processing device in accordance with an aspect of the present invention is a method of controlling an information processing device having a CPU which is capable of carrying out processing for communication with an external device, the information processing device including a storage section configured to store first frequency setting information which is referred to at start-up of the information processing device, the first frequency setting information containing a processing load of the CPU and an operating frequency of the CPU both of which are brought into correspondence with each other, the method including a defining step of, in a case where a current value of communication throughput is equal to or greater than a first reference value or in a case where an expected value of the communication throughput is equal to or greater than a second reference value, defining an operating frequency of the CPU as a value equal to or greater than an operating frequency brought into correspondence with a current processing load in the first frequency setting information.

Yet further, in order to solve the above problem, a method of controlling an information processing device in accordance with an aspect of the present invention is a method of controlling an information processing device having a CPU which is capable of carrying out processing for communication with an external device, the information processing device including a storage section configured to store first frequency setting information which is referred to at start-up of the information processing device, the first frequency setting information containing a processing load of the CPU and an operating frequency of the CPU both of which are brought into correspondence with each other, the method including a defining step of, in a case where the information processing device is in communication, defining an operating frequency of the CPU as a value equal to or greater than an operating frequency brought into correspondence with a current processing load in the first frequency setting information.

### Advantageous Effects of Invention

An aspect of the present invention yields the effect of carrying out communication processing without impairing the comfort of a user.

### BRIEF DESCRIPTION OF DRAWINGS

FIG. 1 is a block diagram illustrating an example of main components of a smartphone in accordance with Embodiments 1 to 3 of the present invention.

FIG. 2 is a diagram illustrating an example of frequency settings that can be applied to the smartphone in accordance with Embodiment 1.

FIG. 3 is a diagram illustrating data structure of the application setting stored in a storage section of the smartphone in accordance with Embodiment 1 and a specific example of the application setting.

FIG. 4 is a flowchart illustrating an example flow of a frequency defining process carried out by the smartphone in accordance with Embodiment 1.

FIG. 5 is a diagram illustrating an example of frequency settings that can be applied to the smartphone in accordance with Embodiment 2.

FIG. 6 is a flowchart illustrating an example flow of a frequency defining process carried out by the smartphone in accordance with Embodiment 2.

FIG. 7 is a diagram illustrating an example of frequency settings that can be applied to the smartphone in accordance with Embodiment 3.

FIG. 8 is a flowchart illustrating an example flow of a frequency defining process carried out by the smartphone in accordance with Embodiment 3.

FIG. 9 is a block diagram illustrating an example of main components of a smartphone in accordance with Embodiment 4.

FIG. 10 is a flowchart illustrating an example flow of a frequency defining process carried out by the smartphone in accordance with Embodiment 4.

FIG. 11 is a block diagram illustrating an example of main components of a smartphone in accordance with Embodiment 5.

FIG. 12 is a flowchart illustrating an example flow of a frequency defining process carried out by the smartphone in accordance with Embodiment 5.

### DESCRIPTION OF EMBODIMENTS

### Embodiment 1

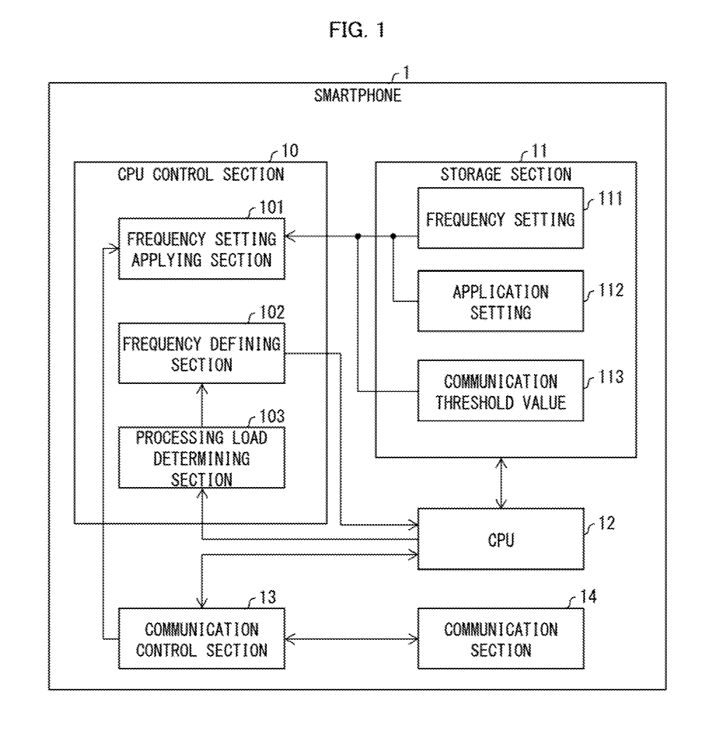

The following description will discuss Embodiment 1 in accordance with the present invention in detail with reference to FIGS. 1 to 4. The present disclosure describes an example of applying an information processing device in accordance with an aspect of the present invention to a smartphone 1. An application example of the information processing device in accordance with an aspect of the present invention is not limited to a smartphone. Specifically, the information processing device in accordance with an aspect of the present invention is applicable to an information processing device having a central processing unit (CPU) which is capable of carrying out processing relating to communications.

(Main Components of Smartphone 1)

First, main components of the smartphone 1 will be described with reference to FIGS. 1 to 3. FIG. 1 is a block diagram illustrating an example of main components of the smartphone 1. In FIG. 1, members having little to do with feature points of the present invention are omitted. Further, these members are not described in the present disclosure.

The smartphone 1 includes a CPU control section 10, a storage section 11, a CPU 12, a communication control section 13, and a communication section 14. The CPU control section 10 controls operations of the CPU 12. The storage section 11 stores various data which the smartphone 1 uses. The CPU 12 centrally controls the individual sections of the smartphone 1. For example, the CPU 12 causes the communication control section 13 to carry out processing for communication with an external device. The communication control section 13 controls wireless communication of the communication section 14 with an external device. The communication section 14 is controlled by the communication control section 13 and carries out wireless communication with an external device.

Further, the CPU control section 10 at least includes a frequency setting applying section 101, a frequency defining section 102 (defining section), and a processing load determining section 103. The storage section 11 at least stores a frequency setting 111 (frequency setting information), an application setting 112, and a communication threshold value 113.

The frequency setting applying section 101 applies to the smartphone 1 a frequency setting for determining an operating frequency of the CPU 12. Note that “to apply the frequency setting” is “to set the frequency setting to a frequency setting which is referred to by the frequency defining section 102”. The frequency setting applying section 101 in accordance with Embodiment 1 applies any of a plurality of frequency settings based on a predetermined condition. The plurality of frequency settings are stored as the frequency setting 111 in the storage section 11. Each of the frequency settings is information indicating a correspondence between the processing load of the CPU 12 (hereinafter referred to as “CPU load”) and the operating frequency of the CPU (hereinafter referred to as “CPU frequency”).

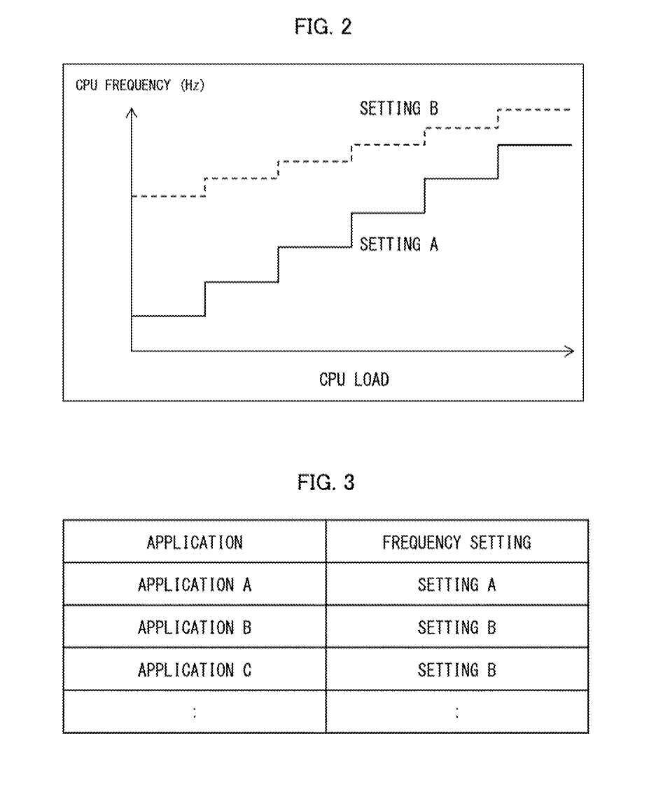

Here, details of the frequency settings will be described with reference to FIG. 2. FIG. 2 is a diagram illustrating an example of frequency settings that can be applied to the smartphone 1 in accordance with Embodiment 1. In FIG. 2, the frequency settings are represented in a graph showing the correspondence between a value of the CPU load and a value of the CPU frequency. The storage section 11 may retain the individual frequency settings as a table in which a value of the CPU load and a value of the CPU frequency are brought into correspondence with each other. The relationship between the CPU load and CPU frequency in the frequency settings need only be a relationship such that the value of the CPU frequency increases monotonously when the value of the CPU load increases. Note that the “monotonous increase” means that, when the value of the CPU load increases, the value of the CPU frequency does not decrease. For example, the “monotonous increase” may be a relationship such that, as the CPU load increases, the CPU frequency increases stepwise as shown in FIG. 2 or may be a relationship such that, as the CPU load increases, the CPU frequency increases in a linear manner or in a curved manner.

In the example shown in FIG. 2, the frequency setting 111 contains a frequency setting A (first frequency setting information) and a frequency setting B (second frequency setting information).

The frequency setting A is a frequency setting which is applied to the smartphone 1 by the frequency setting applying section 101 when the smartphone 1 is started up. In other words, the frequency setting A is a default frequency setting. Note that this statement does not intend to limit a timing at which the frequency setting A is applied to the smartphone 1 to a time of startup of the smartphone 1. A timing at which the frequency setting A is applied to the smartphone 1, other than the time of startup, will be described later.

The frequency setting B is a frequency setting such that a CPU frequency is equal to or greater than a CPU frequency in the frequency setting A under a condition in which a CPU load in the frequency setting B is equal to a CPU load in the frequency setting A. Note that in the example shown in FIG. 2, the frequency setting B is such that a CPU frequency is greater than a CPU frequency in the frequency setting A under a condition in which a CPU load in the frequency setting B is equal to a CPU load in the frequency setting A. However, the frequency setting B may be arranged such that there is a range in which a CPU frequency is equal to a CPU frequency in the frequency setting A under a condition in which a CPU load in the frequency setting B is equal to a CPU load in the frequency setting A. The frequency setting applying section 101 in accordance with Embodiment 1 applies the frequency setting A or the frequency setting B to the smartphone 1 based on a predetermined condition.

Here, the predetermined condition in accordance with Embodiment 1 will be described. The frequency setting applying section 101 in accordance with Embodiment 1 applies the frequency setting A to the smartphone 1 in a case where the smartphone 1 satisfies a setting A application condition, which is a condition for application of the frequency setting A. Further, the frequency setting applying section 101 applies the frequency setting B to the smartphone 1 in a case where the smartphone 1 satisfies a setting B application condition, which is a condition for application of the frequency setting B. Note that the setting A application condition and the setting B application condition, and a setting C application condition and a setting D application condition, both of which will be described in other Embodiments later, are referred to as “application conditions” in a case where there is no need to distinguish them from each other.

A first setting A application condition in accordance with Embodiment 1 is a condition that (i) a current value of communication throughput is equal to or greater than a first threshold value and (ii) a communication time exceeds a threshold value (third reference value; hereinafter referred to as “communication time threshold value”). Further, a second setting A application condition is a condition that an application (hereinafter referred to as “app”) brought into correspondence with the frequency setting A is running in the smartphone 1. The “communication time” is a duration (total communication time) between the start of communication with an external device and a current time. Note that in a case where the communication with the external device has ended, a value of the communication time is reset. Further, the app brought into correspondence with the frequency setting A is, for example, an app by which continuous communications are carried out over a prolonged period of time. Specifically, the app brought into correspondence with the frequency setting A is an app such that an expected communication time between the start of communication with an external device and the end of the communication with the external device is equal to or greater than a reference value (fourth reference value; hereinafter referred to as “communication time reference value”). The communication time reference value may be, for example, a value which is the same as the communication time threshold value or may be a value different from the communication time threshold value. Thus, the communication time threshold value is a numerical value to be compared with the communication time. Further, the communication time reference value is a numerical value to be compared with the expected communication time. In a case where the smartphone 1 satisfies any of these two conditions, the frequency setting applying section 101 in accordance with Embodiment 1 determines that the smartphone 1 satisfies the setting A application condition, and applies the frequency setting A to the smartphone 1. Note that the communication throughput is a communication traffic volume per unit time.

The frequency setting A shown in FIG. 2 is a frequency setting such that a CPU frequency is less than a CPU frequency in the frequency setting B under a condition in which a CPU load in the frequency setting A is equal to a CPU load in the frequency setting B. This allows the smartphone 1 to reduce heat generated by the CPU 12 due to communications over a prolonged period of time. Thus, the smartphone 1 can prevent the processing capacity of the CPU 12 from being decreased due to heat generation.

A first setting B application condition in accordance with Embodiment 1 is a condition that a current value of the communication throughput is equal to or greater than a second threshold value (first reference value). The second threshold value may be, for example, a value based on communication throughput of an app which is generally known to require a high communication throughput (e.g., a game app which realizes a match between different users through wireless communications between them). Further, a second setting B application condition is a condition that an app brought into correspondence with the frequency setting B is running in the smartphone 1. The app brought into correspondence with the frequency setting B is, for example, an app that involves a high communication throughput. Specifically, the app brought into correspondence with the frequency setting B is an app such that an expected value of communication throughput is equal to or greater than a reference value (second reference value; referred to as “throughput reference value”). The throughput reference value may be, for example, a value which is the same as the second threshold value or may be a value different from the second threshold value. Thus, the second threshold value is a numerical value to be compared with a current value of communication throughput. Further, the throughput reference value is a numerical value to be compared with an expected value of communication throughput. In a case where the smartphone 1 satisfies any of these two conditions, the frequency setting applying section 101 in accordance with Embodiment 1 determines that the smartphone 1 satisfies the setting B application condition, and applies the frequency setting B to the smartphone 1.

The frequency setting B shown in FIG. 2 is a frequency setting such that a CPU frequency is greater than a CPU frequency in the frequency setting A under a condition in which a CPU load in the frequency setting B is equal to a CPU load in the frequency setting A. This allows the smartphone 1 to ensure the processing capacity of the CPU 12 for carrying out communication processing even in a case where the CPU load is increased with increased communication throughput. Thus, the smartphone 1 can carry out communication processing without decreasing the communication throughput.

Note that in a case where the smartphone 1 satisfies both the setting A application condition and the setting B application condition, the frequency setting applying section 101 may apply the frequency setting A to the smartphone 1. Alternatively, in a case where the smartphone 1 satisfies both the setting A application condition and the setting B application condition, the frequency setting applying section 101 may apply the frequency setting B to the smartphone 1. Further, the frequency setting applying section 101 may assign priorities to the above four conditions. In such an example case, in a case where a condition having the highest priority, among the conditions which the smartphone 1 satisfies, belongs to the setting A application condition, the frequency setting applying section 101 applies the frequency setting A to the smartphone 1. Further, in a case where a condition having the highest priority, among the conditions which the smartphone 1 satisfies, belongs to the setting B application condition, the frequency setting applying section 101 applies the frequency setting B to the smartphone 1.

In a case where the smartphone 1 does not satisfy any of the application conditions, the frequency setting applying section 101 applies the frequency setting A to the smartphone 1. That is, the frequency setting A can also be expressed as a frequency setting to be applied to the smartphone 1 at normal times. This applies to other embodiments described later. The frequency setting A may be applied to the smartphone 1 at other timing(s). For example, when a remaining battery level of the smartphone 1 is equal to or less than a predetermined threshold value, the frequency setting A may be applied to the smartphone 1.

The frequency setting applying section 101 compares a value of the communication throughput with the first threshold value to determine whether the communication throughput is equal to or greater than the first threshold value. Further, the frequency setting applying section 101 compares a value of the communication throughput with the second threshold value to determine whether the communication throughput is equal to or greater than the second threshold value. Note that the frequency setting applying section 101 obtains a value of the communication throughput from the communication control section 13. Further, the frequency setting applying section 101 reads the first threshold value and the second threshold value from the storage section 11. The first threshold value and the second threshold value are stored as the communication threshold value 113 in the storage section 11.

Note that a magnitude relationship between the first threshold value and the second threshold value is not limited to any particular relationship. For example, the first threshold value can be greater than the second threshold value, or the first threshold value can be less than the second threshold value.

Further, the frequency setting applying section 101 compares a value of the communication time with the communication time threshold value to determine whether the communication time exceeds the communication time threshold value. Note that the frequency setting applying section 101 obtains a value of the communication time from the communication control section 13. Further, the frequency setting applying section 101 reads the communication time threshold value from the storage section 11. The communication time threshold value is stored as the communication threshold value 113 in the storage section 11. Note that the communication threshold value 113 is a threshold value of a value related to wireless communications. As described earlier, the storage section 11 in accordance with Embodiment 1 stores the first threshold value, the second threshold value, and the communication time threshold value as the communication threshold value 113.

Further, the frequency setting applying section 101 determines which of the frequency settings, i.e. the frequency setting A and the frequency setting B, an app running in the smartphone 1 (hereinafter referred to as “running app”) is brought into correspondence with. In so doing, the frequency setting applying section 101 reads the application setting 112 from the storage section 11. Here, details of the application setting 112 will be described with reference to FIG. 3. FIG. 3 is a diagram illustrating data structure of the application setting 112 and a specific example thereof. The following description assumes that, in Embodiment 1, the application setting 112 has data structure represented in a tabular form as illustrated in FIG. 3. Note, however, that the data structure represented in a tabular form is one example, which does not intend to limit the data structure of the application setting 112 to the data structure represented in a tabular form.

As illustrated in FIG. 3, the application setting 112 is such that app identification information for identifying an app is brought into correspondence with setting identification information for identifying a frequency setting. Note that in FIG. 3, for convenience of explanation, the application identification information and the setting identification information are represented as texts indicating names of apps and names of frequency settings, respectively. However, the application identification information and the setting identification information need only be information by which an app can be identified and information by which a frequency setting can be identified, respectively. For example, the application identification information and the setting identification information may be an alphabetic character string, a numeric character string, or an alphanumeric character string that is a combination of alphabetic characters and numeric characters. The frequency setting applying section 101 refers to the application setting 112 to determine a frequency setting brought into correspondence with a running app.

Note that a method of determining a frequency setting to be brought into correspondence with each app is not limited to any particular method. For example, a producer of an app may decide a frequency setting to be brought into correspondence with the app. In such an example case, the producer of the app may add appropriate setting identification information to the app based on characteristics of the app. In one example, in the case of an app that involves a high communication throughput, a producer of the app may add setting identification information indicating the frequency setting B to the app. In another example, in the case of an app that requires continuous communications over a prolonged period of time, a producer of the app may add setting identification information indicating the frequency setting A to the app. The CPU 12, when the app is installed, brings the setting identification information into correspondence with the application identification information and adds the setting identification information to the application setting 112. Note that the setting identification information may be, for example, an upper limit value of the operating frequency.

Alternatively, a user of the smartphone 1 may decide a frequency setting to be brought into correspondence with each app by making an entry through manipulation of an input section (not illustrated) of the smartphone 1. Thus, the user can apply a frequency setting based on the user's impression about a time required for communication and a speed at which an application runs. Alternatively, the CPU 12 or the CPU control section 10 may determine a frequency setting to be brought into correspondence with each app, based on communication throughput and/or communication time of each app.

The processing load determining section 103 determines a CPU load of the CPU 12. The processing load determining section 103 monitors the CPU 12 at every predetermined time to determine the CPU load. Then, the processing load determining section 103 outputs a value of the CPU load thus determined to the frequency defining section 102. Note that in Embodiment 1, the processing load determining section 103 determines a utilization ratio of the CPU 12 (hereinafter referred to as “CPU utilization ratio”) as the CPU load. The CPU utilization ratio is a percentage of the operating time of a program that occupies the CPU 12 in a unit time. Note that the CPU utilization ratio determined as the CPU load by the processing load determining section 103 may be replaced with, for example, an average value of the number of processes that wait for CPU allocation.

The frequency defining section 102 refers to the frequency setting and the CPU load to define the CPU frequency. The frequency setting is a frequency setting that the frequency setting applying section 101 has applied to the smartphone 1 (hereinafter referred to as “applied setting”). Further, the CPU load is a CPU utilization ratio obtained from the processing load determining section 103 (hereinafter referred to as “obtained utilization ratio”). The frequency defining section 102 defines the CPU frequency brought into correspondence with the obtained utilization ratio at the applied setting. Then, the frequency defining section 102 causes the CPU 12 to operate at the CPU frequency thus defined.

In a case where the smartphone 1 satisfies a condition indicating that the smartphone 1 is handling a high communication traffic volume or is going to handle a high communication traffic volume, the frequency defining section 102 defines the CPU frequency as a CPU frequency which is equal to or greater than the CPU frequency brought into correspondence with the determined CPU load in the frequency setting A. In Embodiment 1, in a case where the smartphone 1 satisfies the setting B application condition, the frequency defining section 102 defines the CPU frequency as a CPU frequency which is brought into correspondence with a determined CPU load in the frequency setting B.

In a case where the smartphone 1 satisfies a condition indicating that a communication time of the smartphone 1 is long or is going to be long, the frequency defining section 102 defines the CPU frequency as a CPU frequency which is brought into correspondence with a determined CPU load in the frequency setting A. Note that in Embodiment 1, the condition indicating that a communication time of the smartphone 1 is long or is going to be long is the setting A application condition described above.

(Flow of Frequency Defining Process)

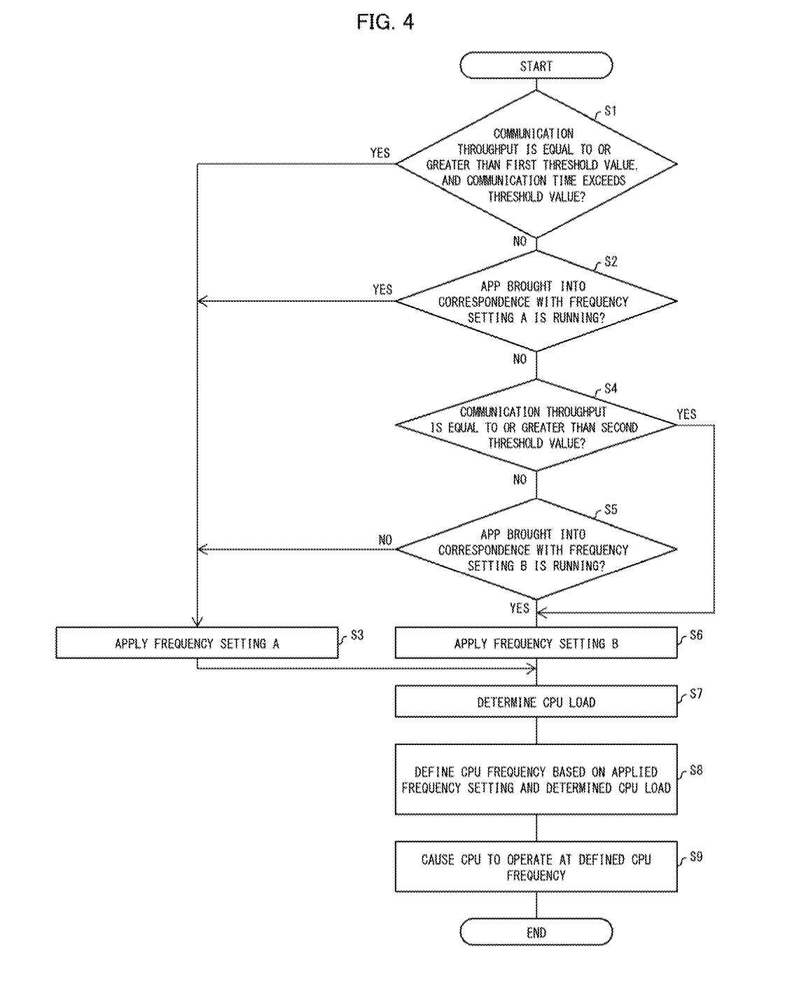

Next, the following description will discuss a flow of frequency defining process carried out in the smartphone 1 in accordance with Embodiment 1, with reference to FIG. 4. FIG. 4 is a flowchart illustrating an example flow of the frequency defining process.

First, the frequency setting applying section 101 determines whether the communication throughput is equal to or greater than the first threshold value and whether the communication time exceeds a threshold value (step S1; hereinafter the term “step” will be omitted). In a case where the frequency setting applying section 101 determines that the communication throughput is equal to or greater than the first threshold value and that the communication time exceeds the threshold value (YES in S1), the frequency setting applying section 101 applies the frequency setting A to the smartphone 1 (S3).

In a case where the frequency setting applying section 101 determines that the communication throughput is less than the first threshold value or that the communication time does not exceed the threshold value (NO in S1), the frequency setting applying section 101 determines whether an app brought into correspondence with the frequency setting A is running (S2). In a case where the frequency setting applying section 101 determines that an app brought into correspondence with the frequency setting A is running (YES in S2), the frequency setting applying section 101 applies the frequency setting A to the smartphone 1 (S3).

In a case where the frequency setting applying section 101 determines that an app brought into correspondence with the frequency setting A is not running (NO in S2), the frequency setting applying section 101 determines whether the communication throughput is equal to or greater than the second threshold value (S4). In a case where the frequency setting applying section 101 determines that the communication throughput is equal to or greater than the second threshold value (YES in S4), the frequency setting applying section 101 applies the frequency setting B to the smartphone 1 (S6).

In a case where the frequency setting applying section 101 determines that the communication throughput is less than the second threshold value (NO in S4), the frequency setting applying section 101 determines whether an app brought into correspondence with the frequency setting B is running (S5). In a case where the frequency setting applying section 101 determines that an app brought into correspondence with the frequency setting B is running (YES in S5), the frequency setting applying section 101 applies the frequency setting B to the smartphone 1 (S6). In a case where the frequency setting applying section 101 determines that an app brought into correspondence with the frequency setting B is not running (NO in S5), the frequency setting applying section 101 applies the frequency setting A to the smartphone 1 (S3).

Subsequently, the processing load determining section 103 determines the CPU load (S7; determining step). The processing load determining section 103 outputs a value of the CPU load thus determined to the frequency defining section 102. Finally, the frequency defining section 102 defines a CPU frequency based on the frequency setting applied to the smartphone 1 and the determined CPU load (S8; defining step). Then, the frequency defining section 102 causes the CPU 12 to operate at the CPU frequency thus defined (S9). This is the end of the frequency defining process in accordance with Embodiment 1.

As described above, the smartphone 1 in accordance with an aspect of the present invention is configured such that, under circumstances where a communication traffic volume is high, the frequency setting B is applied to the smartphone 1, wherein the frequency setting B is a frequency setting such that a CPU frequency is equal to or higher than a CPU frequency in the frequency setting A under a condition in which a CPU load in the frequency setting B is equal to a CPU load in the frequency setting A. This allows the smartphone 1 to ensure, in advance, the processing capacity of the CPU 12 for carrying out communication processing under circumstances where a communication traffic volume is high. Thus, even when the CPU load is abruptly increased, the smartphone 1 can carry out communication processing without lowering the communication throughput. Therefore, the smartphone 1 can carry out communication processing without impairing the comfort of the user.

Further, under circumstances where the smartphone 1 carries out continuous communications over a prolonged period of time, the frequency setting A is applied to the smartphone 1. In such a case, the CPU frequency versus the CPU load becomes lower, as compared to when the frequency setting B is applied to the smartphone 1. This allows the smartphone 1 to reduce power consumption. Thus, the smartphone 1 can prevent increased temperature of the CPU 12. Consequently, the smartphone 1 can prevent decreased performance of the CPU 12. Therefore, the smartphone 1 can provide stable communication throughput and stable performance of the CPU 12.

Furthermore, the smartphone 1, unlike the technique disclosed in Patent Literature 1, does not carry out a CPU frequency change with which to determine whether such a change has an influence on the communication throughput. Thus, in the smartphone 1, there occurs no variation in performance of an app based on a CPU frequency change. Accordingly, it is possible to prevent an app from suddenly running fast or suddenly running slowly. This allows the user to use the smartphone 1 without impairing user's operating comfort of the smartphone 1.

### Embodiment 2

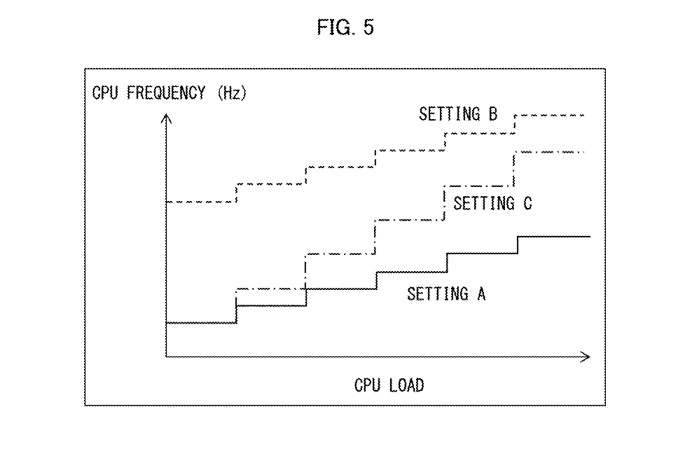

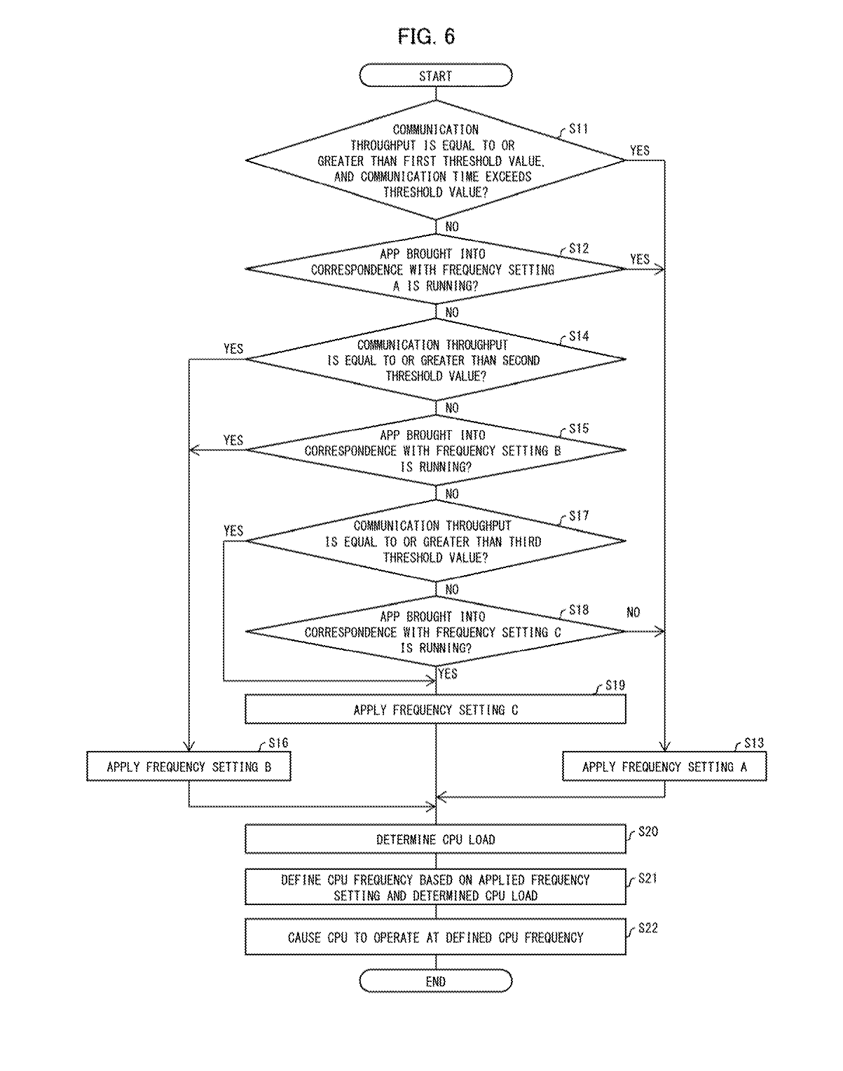

The following description will discuss another embodiment of the present invention with reference to FIGS. 5 and 6. Note that in Embodiment 2 and subsequent embodiments, members having functions identical to those of members discussed in Embodiment 1 are, for convenience, given the same reference signs, and descriptions of such members are omitted.

Embodiment 1 has dealt with an example case where the number of frequency settings that can be applied to the smartphone 1 is two. However, the number of the frequency settings is not limited to two. Embodiment 2 will deal with an example case where the number of frequency settings that can be applied to the smartphone 1 is three.

FIG. 5 is a diagram illustrating an example of frequency settings that can be applied to the smartphone 1 in accordance with Embodiment 2. The frequency setting 111 in accordance with Embodiment 2 includes not only the frequency settings A and B, which have been described in Embodiment 1, but also the frequency setting C. The frequency setting C is a frequency setting such that a CPU frequency is equal to or greater than a CPU frequency in the frequency setting A under a condition in which a CPU load in the frequency setting C is equal to a CPU load in the frequency setting A. Further, the frequency setting C is a frequency setting such that a CPU frequency is equal to or less than a CPU frequency in the frequency setting B under a condition in which a CPU load in the frequency setting C is equal to a CPU load in the frequency setting B. Note that in the example shown in FIG. 5, the frequency setting B and the frequency setting C are such that a CPU frequency is greater than a CPU frequency in the frequency setting A under a condition in which a CPU load in the frequency settings B and C is equal to a CPU load in the frequency setting A. However, the frequency setting B and the frequency setting C may be arranged such that there is a range in which a CPU frequency is equal to a CPU frequency in the frequency setting A under a condition in which a CPU load in the frequency settings B and C is equal to a CPU load in the frequency setting A. The frequency setting applying section 101 in accordance with Embodiment 2 applies any of the frequency setting A, the frequency setting B, and the frequency setting C to the smartphone 1 based on a predetermined condition.

Here, the predetermined condition in accordance with Embodiment 2 will be described. Note that the setting A application condition and the setting B application condition in accordance with Embodiment 2 are the same as those described in Embodiment 1, and descriptions of the setting A application condition and the setting B application condition are thus omitted. The frequency setting applying section 101 in accordance with Embodiment 2 applies the frequency setting C to the smartphone 1 in a case where the smartphone 1 satisfies the setting C application condition, which is a condition for application of the frequency setting C.

A first setting C application condition in accordance with Embodiment 2 is a condition that a current value of the communication throughput is equal to or greater than a third threshold value. The third threshold value is less than the second threshold value. Further, a second setting C application condition is a condition that an app brought into correspondence with the frequency setting C is running in the smartphone 1. The app brought into correspondence with the frequency setting C is, for example, an app that involves a medium communication throughput. For example, in the case of a game app which realizes a match between different users through wireless communications between them, communication throughput is high. Thus, the game app is brought into correspondence with the frequency setting B. In the case of a so-called chat app which realizes transmission of messages between different users, communication throughput is less than the communication throughput that the game app involves. Thus, the chat app is brought into correspondence with the frequency setting C. Note that the above correspondences between the apps and the frequency settings are an example. In a case where the smartphone 1 satisfies any of these two conditions, the frequency setting applying section 101 in accordance with Embodiment 2 determines that the smartphone 1 satisfies the setting C application condition, and applies the frequency setting C to the smartphone 1.

The frequency setting C shown in FIG. 5 is a frequency setting such that a CPU frequency is equal to or greater than a CPU frequency in the frequency setting A under a condition in which a CPU load in the frequency setting C is equal to a CPU load in the frequency setting A. Note that the frequency setting C is preferably such that, in a case where a CPU load takes a large value, a CPU frequency is greater than a CPU frequency in the frequency setting A as shown in FIG. 5 under a condition in which a CPU load in the frequency setting C is equal to a CPU load in the frequency setting A. Further, the frequency setting C is a frequency setting such that a CPU frequency is lower than a CPU frequency in the frequency setting B under a condition in which a CPU load in the frequency setting C is equal to a CPU load in the frequency setting B. Further, as described earlier, the frequency setting C is applied in a case where the communication traffic volume is medium. This allows the smartphone 1 in accordance with Embodiment 2 to ensure a processing capacity of the CPU 12 appropriate to a communication traffic volume. Thus, the smartphone 1 can prevent both decreased communication throughput caused by lack of the processing capacity of the CPU 12 and decreased communication throughput caused by heat generation.

Note that in a case where the smartphone 1 satisfies all of the application conditions, the frequency setting applying section 101 may apply the frequency setting A to the smartphone 1. Alternatively, in a case where the smartphone 1 satisfies all of the application conditions, the frequency setting applying section 101 may apply the frequency setting B or the frequency setting C to the smartphone 1. Further, the frequency setting applying section 101 may assign priorities to the above six conditions. In such an example case, in a case where a condition having the highest priority, among the conditions which the smartphone 1 satisfies, belongs to the setting A application condition, the frequency setting applying section 101 applies the frequency setting A to the smartphone 1. Further, in a case where a condition having the highest priority, among the conditions which the smartphone 1 satisfies, belongs to the setting B application condition, the frequency setting applying section 101 applies the frequency setting B to the smartphone 1. Further, in a case where a condition having the highest priority, among the conditions which the smartphone 1 satisfies, belongs to the setting C application condition, the frequency setting applying section 101 applies the frequency setting C to the smartphone 1.

The frequency setting applying section 101 in accordance with Embodiment 2 further compares a value of the communication throughput with the third threshold value to determine whether the communication throughput is equal to or greater than the third threshold value. Note that the frequency setting applying section 101 reads the third threshold value from the storage section 11. The third threshold value is stored as the communication threshold value 113 in the storage section 11. That is, the communication threshold value 113 in accordance with Embodiment 2 further includes the third threshold value. Further, the frequency setting applying section 101 in accordance with Embodiment 2 determines which of the frequency settings, i.e. the frequency setting A, the frequency setting B, and the frequency setting C, a running app is brought into correspondence with. In so doing, the frequency setting applying section 101 reads the application setting 112 from the storage section 11. That is, the application setting 112 in accordance with Embodiment 2 can contain a correspondence between an app and the frequency setting C.

(Flow of Frequency Defining Process)

Next, the following description will discuss a flow of frequency defining process carried out in the smartphone 1 in accordance with Embodiment 2, with reference to FIG. 6. FIG. 6 is a flowchart illustrating an example flow of the frequency defining process. Note that steps S11 to S16 and steps S20 to S22 are the same as the steps S1 to S9 in FIG. 4, respectively, and thus are not described below.

In a case where the frequency setting applying section 101 determines that an app brought into correspondence with the frequency setting B is not running (NO in S15), the frequency setting applying section 101 determines whether the communication throughput is equal to or greater than the third threshold value (S17). In a case where the frequency setting applying section 101 determines that the communication throughput is equal to or greater than the third threshold value (YES in S17), the frequency setting applying section 101 applies the frequency setting C to the smartphone 1 (S19).

In a case where the frequency setting applying section 101 determines that the communication throughput is less than the third threshold value (NO in S17), the frequency setting applying section 101 determines whether an app brought into correspondence with the frequency setting C is running (S18). In a case where the frequency setting applying section 101 determines that an app brought into correspondence with the frequency setting C is running (YES in S18), the frequency setting applying section 101 applies the frequency setting C to the smartphone 1 (S19). In a case where the frequency setting applying section 101 determines that an app brought into correspondence with the frequency setting C is not running (NO in S18), the frequency setting applying section 101 applies the frequency setting A to the smartphone 1 (S13).

### Embodiment 3

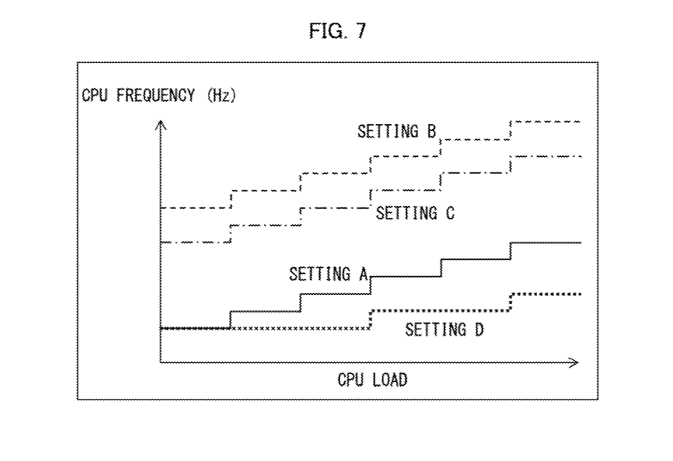

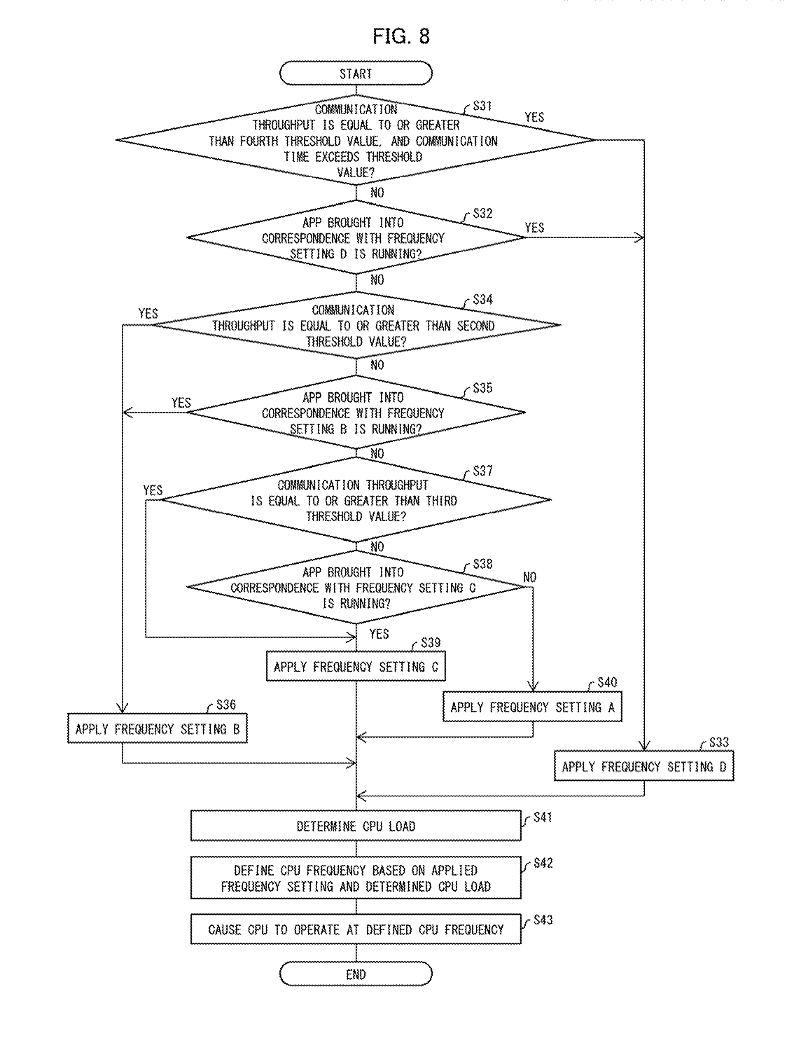

The following description will discuss still another embodiment of the present invention with reference to FIGS. 7 and 8. Embodiment 3 will deal with an example case where the number of frequency settings that can be applied to the smartphone 1 is four.

FIG. 7 is a diagram illustrating an example of frequency settings that can be applied to the smartphone 1 in accordance with Embodiment 3. The frequency setting 111 in accordance with Embodiment 3 includes not only the frequency settings A, B, and C, which have been described in Embodiment 2, but also the frequency setting D (third frequency setting information). The frequency setting D is a frequency setting such that a CPU frequency is equal to or less than a CPU frequency in the frequency setting A under a condition in which a CPU load in the frequency setting D is equal to a CPU load in the frequency setting A. Note that in the example shown in FIG. 7, the frequency setting D is such that, in a range where a CPU load is low, a CPU frequency is equal to a CPU frequency in the frequency setting A under a condition in which a CPU load in the frequency setting D is equal to a CPU load in the frequency setting A. However, the frequency setting D may be arranged such that, in all ranges, a CPU frequency is less than a CPU frequency in the frequency setting A under a condition in which a CPU load in the frequency setting D is equal to a CPU load in the frequency setting A. The frequency setting applying section 101 in accordance with Embodiment 3 applies any of the frequency setting A, the frequency setting B, the frequency setting C, and the frequency setting D to the smartphone 1 based on a predetermined condition.

Here, the predetermined condition in accordance with Embodiment 3 will be described. Note that the setting B application condition and the setting C application condition in accordance with Embodiment 3 are the same as those described in Embodiment 2, and descriptions of the setting B application condition and the setting C application condition are thus omitted.

In Embodiment 3, the setting A application condition is not set. Only in a case where the smartphone 1 in accordance with Embodiment 3 does not satisfy any of the application conditions, the frequency setting applying section 101 applies the frequency setting A to the smartphone 1.

The frequency setting applying section 101 in accordance with Embodiment 3 applies the frequency setting D to the smartphone 1 in a case where the smartphone 1 satisfies the setting D application condition, which is a condition for application of the frequency setting D.

A first setting D application condition in accordance with Embodiment 3 is a condition that (i) a current value of communication throughput is equal to or greater than a fourth threshold value and (ii) a communication time exceeds the communication time threshold value. Further, a second setting D application condition is a condition that an app brought into correspondence with the frequency setting D is running in the smartphone 1. The app brought into correspondence with the frequency setting D is, for example, an app by which continuous communications are carried out over a prolonged period of time. In a case where the smartphone 1 satisfies any of these two conditions, the frequency setting applying section 101 in accordance with Embodiment 3 determines that the smartphone 1 satisfies the setting D application condition, and applies the frequency setting D to the smartphone 1. Thus, the smartphone 1 can limit, in advance, the CPU frequency versus the CPU load under circumstances where there is a possibility that the processing capacity of the CPU 12 may decrease due to heat generation. Thus, the smartphone 1 can further prevent the processing capacity of the CPU 12 from being decreased due to heat generation.

Note that in a case where the smartphone 1 satisfies all of the application conditions, the frequency setting applying section 101 may apply the frequency setting D to the smartphone 1. Alternatively, in a case where the smartphone 1 satisfies all of the application conditions, the frequency setting applying section 101 may apply any of the frequency setting A, the frequency setting B, and the frequency setting C to the smartphone 1. Further, the frequency setting applying section 101 may assign priorities to the above six conditions. In such an example case, in a case where a condition having the highest priority, among the conditions which the smartphone 1 satisfies, belongs to the setting B application condition, the frequency setting applying section 101 applies the frequency setting B to the smartphone 1. Further, in a case where a condition having the highest priority, among the conditions which the smartphone 1 satisfies, belongs to the setting C application condition, the frequency setting applying section 101 applies the frequency setting C to the smartphone 1. Further, in a case where a condition having the highest priority, among the conditions which the smartphone 1 satisfies, belongs to the setting D application condition, the frequency setting applying section 101 applies the frequency setting D to the smartphone 1.

The frequency setting applying section 101 in accordance with Embodiment 3 compares a value of the communication throughput with the fourth threshold value to determine whether the communication throughput is equal to or greater than the fourth threshold value. Note that the frequency setting applying section 101 reads the fourth threshold value from the storage section 11. The fourth threshold value is stored as the communication threshold value 113 in the storage section 11. That is, the communication threshold value 113 in accordance with Embodiment 3 includes the fourth threshold value, instead of the first threshold value. Further, the frequency setting applying section 101 in accordance with Embodiment 3 determines which of the frequency settings, i.e. the frequency setting B, the frequency setting C, and the frequency setting D, a running app is brought into correspondence with. In so doing, the frequency setting applying section 101 reads the application setting 112 from the storage section 11. That is, the application setting 112 in accordance with Embodiment 3 can contain a correspondence between an app and the frequency setting D. The application setting 112 in accordance with Embodiment 3 does not contain a correspondence between an app and the frequency setting A.

In a case where the smartphone 1 satisfies a condition indicating that a communication time of the smartphone 1 is long or is going to be long, the frequency defining section 102 defines the CPU frequency as a CPU frequency which is equal to or less than a CPU frequency brought into correspondence with a determined CPU load in the frequency setting A. In Embodiment 3, in a case where the smartphone 1 satisfies the setting D application condition, the frequency defining section 102 defines the CPU frequency as a CPU frequency which is brought into correspondence in the frequency setting D.

(Flow of Frequency Defining Process)

Next, the following description will discuss a flow of frequency defining process carried out in the smartphone 1 in accordance with Embodiment 3, with reference to FIG. 8. FIG. 8 is a flowchart illustrating an example flow of the frequency defining process. Note that steps S35 to S39, step S40, and steps S41 to S43 are the same as the steps S15 to S19, the step S13, and the steps S20 to S22 in FIG. 6, respectively, and thus are not described below.

First, the frequency setting applying section 101 determines whether the communication throughput is equal to or greater than the fourth threshold value and whether the communication time exceeds a threshold value (S31). In a case where the frequency setting applying section 101 determines that the communication throughput is equal to or greater than the fourth threshold value and that the communication time exceeds the threshold value (YES in the step S31), the frequency setting applying section 101 applies the frequency setting D to the smartphone 1 (S33).

In a case where the frequency setting applying section 101 determines that the communication throughput is less than the fourth threshold value or that the communication time does not exceed the threshold value (NO in S31), the frequency setting applying section 101 determines whether an app brought into correspondence with the frequency setting D is running (S32). In a case where the frequency setting applying section 101 determines that an app brought into correspondence with the frequency setting D is running (YES in S32), the frequency setting applying section 101 applies the frequency setting D to the smartphone 1 (S33).

In a case where the frequency setting applying section 101 determines that an app brought into correspondence with the frequency setting D is not running (NO in S32), the frequency setting applying section 101 determines whether the communication throughput is equal to or greater than the second threshold value (S34). Note that processes to be carried out in a case where YES and NO in the step S34 are the same as those to be carried out in a case where YES and NO in the step S14 in FIG. 6, and thus are not described.

### Embodiment 4

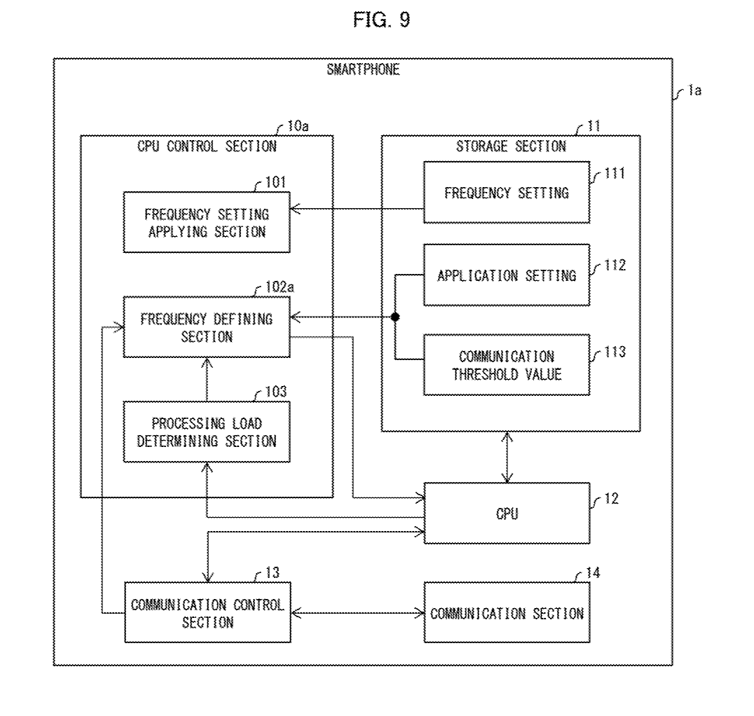

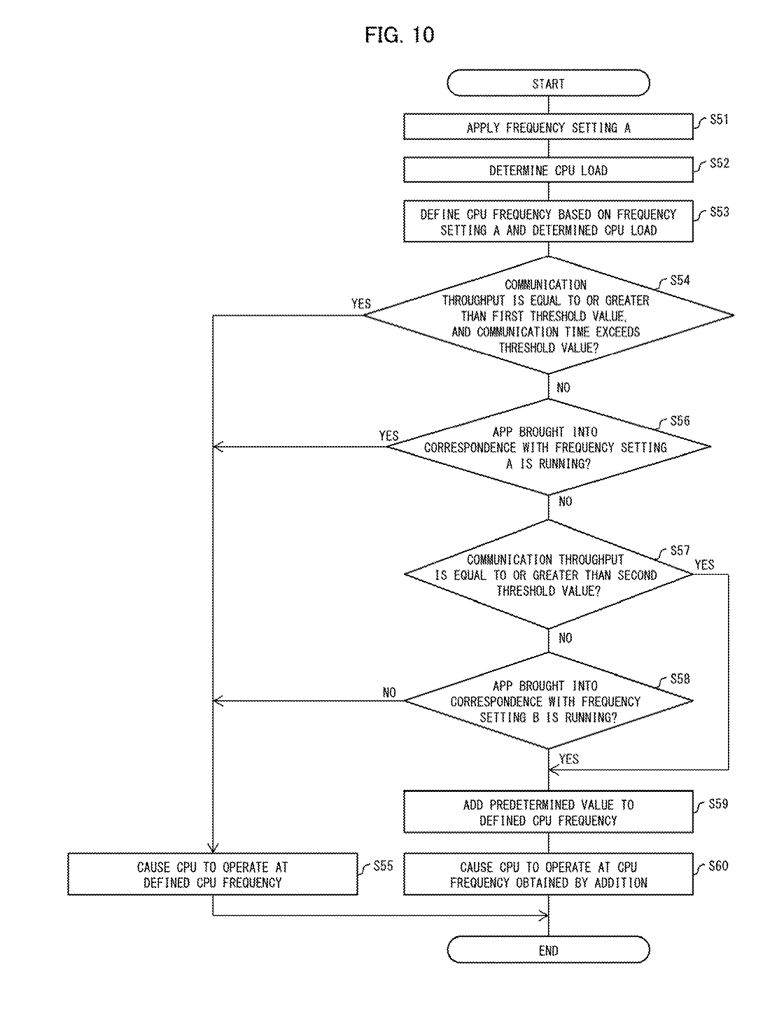

The following description will discuss yet another embodiment of the present invention with reference to FIGS. 9 and 10. Embodiment 4 will deal with a configuration in which a value of a CPU frequency is increased by adding a predetermined value to a CPU frequency defined based on a frequency setting and a CPU load.

FIG. 9 is a block diagram illustrating an example of main components of a smartphone 1a in accordance with Embodiment 4. A difference between the smartphone 1 and the smartphone 1a lies in that the smartphone 1a includes a CPU control section 10a, instead of the CPU control section 10. A difference between the CPU control section 10 and the CPU control section 10a lies in that the CPU control section 10a includes a frequency defining section 102a, instead of the frequency defining section 102.

A frequency setting 111 in accordance with Embodiment 4 includes the frequency setting A only. Thus, the frequency setting applying section 101 in accordance with Embodiment 4 applies the frequency setting A to the smartphone 1a upon start-up of the smartphone 1a.

In a case where the smartphone 1a satisfies a condition indicating that the smartphone 1a is handling a high communication traffic volume or is going to handle a high communication traffic volume (hereinafter referred to as “addition condition”), the frequency defining section 102a defines the CPU frequency as a CPU frequency which is obtained by adding a predetermined value to a CPU frequency brought into correspondence with a determined CPU load in the frequency setting A. That is, the frequency defining section 102a adds a predetermined value to a CPU frequency defined based on the frequency setting A and the CPU load determined by the processing load determining section 103. Then, the frequency defining section 102a defines the CPU frequency of the CPU 12 as a value obtained by the addition. For example, in a case where the smartphone 1a satisfies any of the conditions of the setting B application condition described in Embodiment 1, the frequency defining section 102a in accordance with Embodiment 4 adds a predetermined value to a current CPU frequency.

This allows the smartphone 1a to ensure the processing capacity of the CPU 12 for carrying out communication processing in a case where communication throughput increases or there is a possibility that communication throughput can increase. Thus, the smartphone 1a can shorten a time required for communication processing and avoid the occurrence of an event in which an application runs slowly, as compared to a case where the frequency setting A is applied to the smartphone 1a.

Further, the frequency defining section 102a may be configured such that, in a case where the smartphone 1a satisfies a predetermined condition (hereinafter referred to as “exceptional condition”) different from the addition condition, the frequency defining section 102a does not add a predetermined value to a current CPU frequency even when the smartphone 1a satisfies the addition condition. For example, in a case where the smartphone 1a satisfies any of the conditions of the setting A application condition described in Embodiment 1, the frequency defining section 102a in accordance with Embodiment 4 does not add a predetermined value to a current CPU frequency even when the smartphone 1a satisfies the addition condition. This allows the smartphone 1a to reduce heat generated by the CPU 12 due to communications over a prolonged period of time.

Note that the determination as to whether the addition condition and the exceptional condition are satisfied is the same as that performed by the frequency setting applying section 101 in Embodiment 1, and thus is not detailed here.

(Flow of Frequency Defining Process)

Next, the following description will discuss a flow of frequency defining process carried out in the smartphone 1a in accordance with Embodiment 4, with reference to FIG. 10. FIG. 10 is a flowchart illustrating an example flow of the frequency defining process.

First, the frequency setting applying section 101 applies to the smartphone 1a the frequency setting A (S51). Subsequently, the processing load determining section 103 determines the CPU load (S52). The processing load determining section 103 outputs a value of the CPU load thus determined to the frequency defining section 102a. Subsequently, the frequency defining section 102a defines a CPU frequency based on the frequency setting A and the CPU load thus obtained (S53).

Subsequently, the frequency defining section 102a determines whether the communication throughput is equal to or greater than the first threshold value and whether the communication time exceeds a threshold value (S54). In a case where the frequency defining section 102a determines that the communication throughput is equal to or greater than the first threshold value and that the communication time exceeds a threshold value (YES in S54), the frequency defining section 102a causes the CPU 12 to operate at the CPU frequency defined at step S53 (S55). Then, the frequency defining process ends.

In a case where the frequency defining section 102a determines that the communication throughput is less than the first threshold value or that the communication time does not exceed the threshold value (NO in S54), the frequency defining section 102a determines whether an app brought into correspondence with the frequency setting A is running (S56). In a case where the frequency defining section 102a determines that an app brought into correspondence with the frequency setting A is running (YES in S56), the frequency defining section 102a carries out the process in the step S55. Then, the frequency defining process ends.

In a case where the frequency defining section 102a determines that an app brought into correspondence with the frequency setting A is not running (NO in S56), the frequency defining section 102a determines whether the communication throughput is equal to or greater than the second threshold value (S57). In a case where the frequency defining section 102a determines that the communication throughput is equal to or greater than the second threshold value (YES in S57), the frequency defining section 102a adds a predetermined value to a current CPU frequency (S59). Then, the frequency defining section 102a causes the CPU to operate at a CPU frequency obtained by the addition (S60). Then, the frequency defining process ends.

In a case where the frequency defining section 102a determines that the communication throughput is less than the second threshold value (NO in S57), the frequency defining section 102a determines whether an app brought into correspondence with the frequency setting B is running (S58). In a case where the frequency defining section 102a determines that an app brought into correspondence with the frequency setting B is running (YES in S58), the frequency defining section 102a carries out the process in the step S59 and the process in the step S60. Then, the frequency defining process ends. In a case where the frequency defining section 102a determines that an app brought into correspondence with the frequency setting B is not running (NO in S58), the frequency defining section 102a carries out the process in the step S55. Then, the frequency defining process ends.

As described above, the smartphone 1a in accordance with Embodiment 4 adds a predetermined value to a current CPU frequency in a situation where the smartphone 1a handles a high volume of communication traffic. Then, the smartphone 1a causes the CPU 12 to operate at a CPU frequency obtained by the addition. This allows the smartphone 1a to ensure, in advance, the processing capacity of the CPU 12 for carrying out communication processing even in a case where the CPU load is increased when the smartphone 1a provides a high communication throughput. Thus, even when the CPU load is abruptly increased, the smartphone 1a can carry out communication processing without decreasing the communication throughput. Therefore, the smartphone 1a can carry out communication processing without impairing the comfort of the user. Further, the smartphone 1a need only store only one frequency setting. This allows the smartphone 1a to reduce the amount of data to be stored in the storage section 11. Further, implementation of the smartphone 1a is simplified.

### Embodiment 5

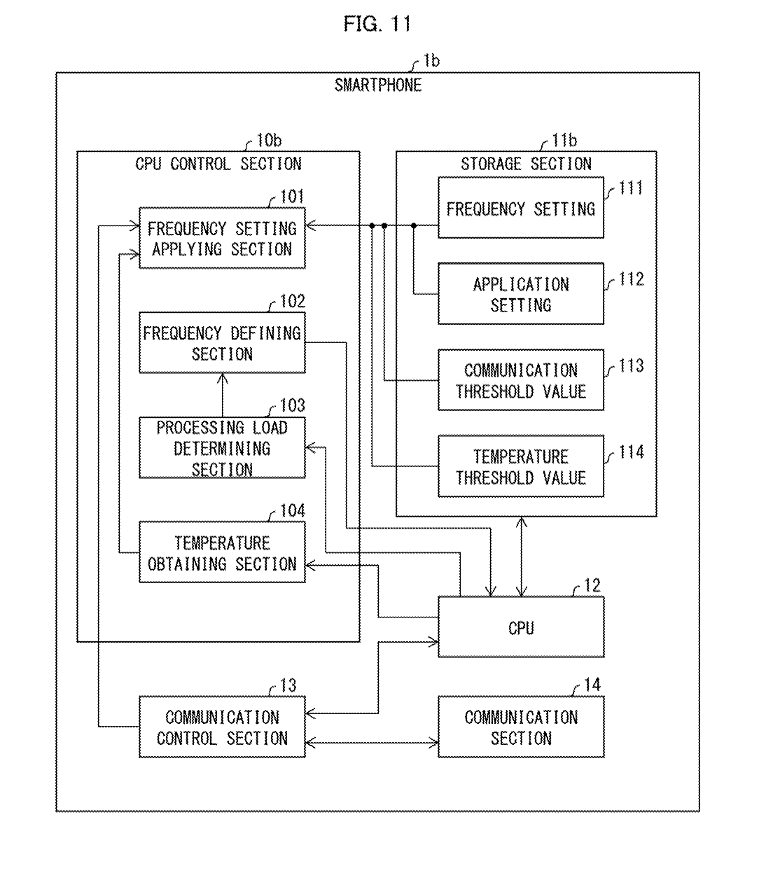

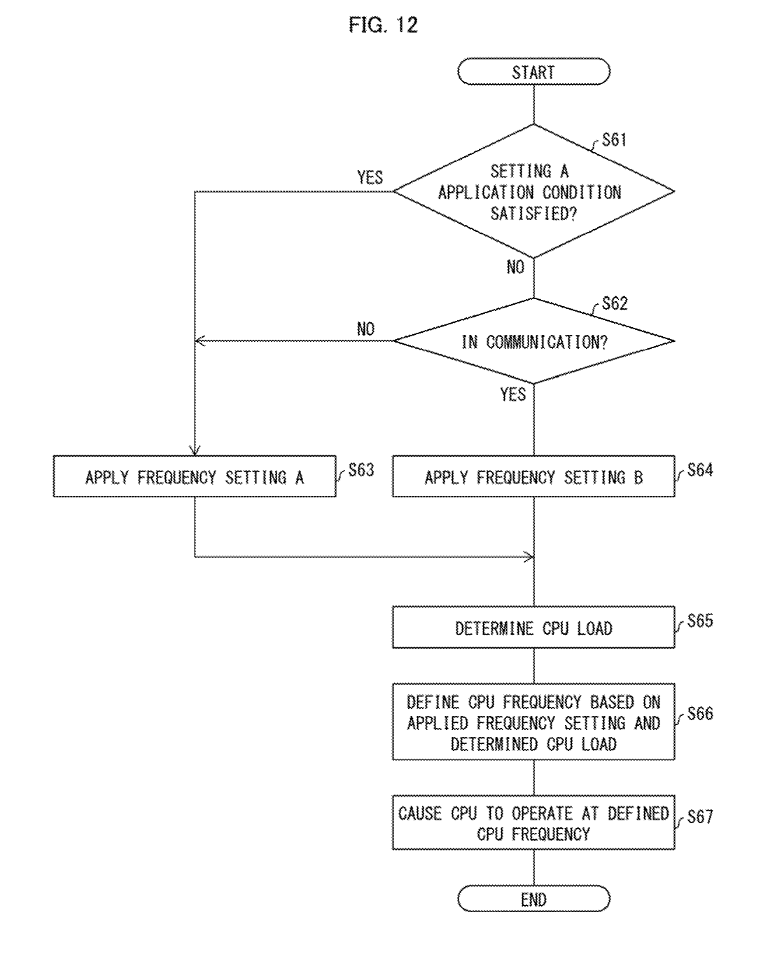

The following description will discuss further another embodiment of the present invention with reference to FIGS. 11 and 12. Embodiment 5 will deal with another example of the setting A application condition and the setting B application condition.

FIG. 11 is a block diagram illustrating an example of main components of a smartphone 1b in accordance with Embodiment 5. A difference between the smartphone 1 and the smartphone 1b lies in that the smartphone 1b includes a CPU control section 10b, instead of the CPU control section 10. Another difference between the smartphone 1 and the smartphone 1b lies in that the smartphone 1b includes a storage section 11b, instead of the storage section 11. A difference between the CPU control section 10 and the CPU control section 10b lies in that the CPU control section 10b additionally includes a temperature obtaining section 104. A difference between the storage section 11 and the storage section 11b lies in that the storage section 11b additionally stores a temperature threshold value 114.

The frequency setting applying section 101 in accordance with Embodiment 5 applies the frequency setting A to the smartphone 1b in a case where the smartphone 1b satisfies a setting A application condition, which is a condition for application of the frequency setting A. Further, the frequency setting applying section 101 applies the frequency setting B to the smartphone 1b in a case where the smartphone 1b satisfies a setting B application condition, which is a condition for application of the frequency setting B.

A first setting A application condition in accordance with Embodiment 5 is a condition that a temperature of the CPU 12 exceeds a temperature threshold value. Further, a second setting A application condition is a condition that an app brought into correspondence with the frequency setting A is running in the smartphone 1b. Still further, a third setting A application condition is a condition that a communication time exceeds the communication time threshold value. In a case where the smartphone 1b satisfies any of these three conditions, the frequency setting applying section 101 in accordance with Embodiment 5 determines that the smartphone 1b satisfies the setting A application condition, and applies the frequency setting A to the smartphone 1b. This allows the smartphone 1b to reduce heat generated by the CPU 12 due to communications over a prolonged period of time. Thus, the smartphone 1b can prevent the processing capacity of the CPU 12 from being decreased due to heat generation.

The setting B application condition in accordance with Embodiment 5 is a condition that the smartphone 1b is in communication. In a case where the smartphone 1b satisfies such a condition, the frequency setting applying section 101 in accordance with Embodiment 5 applies the frequency setting B to the smartphone 1b. This allows the smartphone 1b to ensure, in advance, the processing capacity of the CPU in a situation where there is a possibility that communication throughput can increase. This allows the smartphone 1b to shorten a time required for communication processing and avoid the occurrence of an event in which an application runs slowly, as compared to the case where the frequency setting A is applied to the smartphone 1b.

Note that in a case where the smartphone 1b satisfies both the setting A application condition and the setting B application condition, the frequency setting applying section 101 in accordance with Embodiment 5 may apply the frequency setting A to the smartphone 1b. Alternatively, in a case where the smartphone 1b satisfies both the setting A application condition and the setting B application condition, the frequency setting applying section 101 may apply the frequency setting B to the smartphone 1b.

Further, the frequency setting applying section 101 may assign priorities to the above four conditions. In such an example case, in a case where a condition having the highest priority, among the conditions which the smartphone 1b satisfies, belongs to the setting A application condition, the frequency setting applying section 101 applies the frequency setting A to the smartphone 1b. Further, in a case where a condition having the highest priority, among the conditions which the smartphone 1b satisfies, belongs to the setting B application condition, the frequency setting applying section 101 applies the frequency setting B to the smartphone 1b. For example, in a case where the condition that the smartphone 1b is in communication has a higher priority than the condition that the communication time exceeds the communication time threshold value, the frequency setting applying section 101 applies the frequency setting B to the smartphone 1b even when the communication time exceeds the communication time threshold value.

The frequency setting applying section 101 in accordance with Embodiment 5 does not perform a determination based on a comparison between communication throughput and a threshold value. That is, the communication threshold value 113 in accordance with Embodiment 5 includes the communication time threshold value only. Note that a configuration in which the communication threshold value 113 includes the communication time threshold value only is an example configuration. Information to be included in the communication threshold value 113 is determined according to an application condition. For example, in a case where the application condition includes a condition that requires a comparison between communication throughput and a threshold value, the communication threshold value 113 includes a communication throughput threshold value (e.g., the first threshold value described in Embodiment 1).

Further, the frequency setting applying section 101 determines whether a running app is brought into correspondence with the frequency setting A. In so doing, the frequency setting applying section 101 reads the application setting 112 from the storage section 11. That is, the application setting 112 in accordance with Embodiment 5 can contain only a correspondence between an app and the frequency setting A.

Further, the frequency setting applying section 101 determines whether a temperature of the CPU 12 exceeds the temperature threshold value 114. Note that the frequency setting applying section 101 obtains a value of the temperature from the temperature obtaining section 104. Further, the frequency setting applying section 101 reads the temperature threshold value 114 from the storage section 11. Note that the temperature threshold value 114 need only be a temperature value at which the processing capacity of the CPU 12 decreases.

Further, the frequency setting applying section 101 determines whether the communication control section 13 has caused the communication section 14 to carry out wireless communication. Then, on the basis of a result of the determination, the frequency setting applying section 101 determines whether the smartphone 1b is in communication.

In a case where the smartphone 1b is in communication, the frequency defining section 102 in accordance with Embodiment 5 defines the CPU frequency as a CPU frequency which is equal to or greater than a CPU frequency brought into correspondence with a determined CPU load in the frequency setting A. That is, in a case where the smartphone 1b satisfies the setting B application condition in accordance with Embodiment 5, the frequency defining section 102 defines the CPU frequency as a CPU frequency which is brought into correspondence with a determined CPU load in the frequency setting B.

The temperature obtaining section 104 obtains a temperature of the CPU 12. The temperature obtaining section 104 obtains a value of a temperature of the CPU 12 from a temperature sensor (not illustrated) which measures a temperature of a CPU. Then, the temperature obtaining section 104 outputs the obtained temperature value to the frequency setting applying section 101.

(Flow of Frequency Defining Process)

Next, the following description will discuss a flow of frequency defining process carried out in the smartphone 1b in accordance with Embodiment 5, with reference to FIG. 12. FIG. 12 is a flowchart illustrating an example flow of the frequency defining process. Note that steps S65 to S67 are the same as the steps S7 to S9 in FIG. 4, respectively, and thus are not described below.

First, the frequency setting applying section 101 determines whether the smartphone 1b satisfies the setting A application condition (S61). In a case where the frequency setting applying section 101 determines that the smartphone 1b satisfies any of the conditions of the setting A application condition (YES in S61), the frequency setting applying section 101 applies the frequency setting A to the smartphone 1b (S63).

In a case where the frequency setting applying section 101 determines that the smartphone 1b satisfies none of the conditions of the setting A application condition (NO in S61), the frequency setting applying section 101 determines whether the smartphone 1b is in communication (S62). In a case where the frequency setting applying section 101 determines that the smartphone 1b is in communication (YES in S62), the frequency setting applying section 101 applies the frequency setting B to the smartphone 1b (S64). In a case where the frequency setting applying section 101 determines that the smartphone 1b is not in communication, the frequency setting applying section 101 applies the frequency setting A to the smartphone 1b (S63).

As described above, the smartphone 1b in accordance with an aspect of the present invention is configured such that, in a situation where the smartphone 1b is in communication, the frequency setting B is applied to the smartphone 1b, wherein the frequency setting B is a frequency setting such that a CPU frequency is equal to or greater than a CPU frequency in the frequency setting A under a condition in which a CPU load in the frequency setting B is equal to a CPU load in the frequency setting A. This allows the smartphone 1b to ensure, in advance, the processing capacity of the CPU 12 for carrying out communication processing even in a case where the CPU load is increased later with increased communication throughput. Thus, even when the CPU load is abruptly increased, the smartphone 1b can carry out communication processing without decreasing the communication throughput. Therefore, the smartphone 1b can carry out communication processing without impairing the comfort of the user.

[Variation 1]

An aspect of the present invention may be a combined configuration of the configuration described in Embodiment 2 and the configuration described in Embodiment 4. For example, in a case where the smartphone 1a satisfies any of the conditions of the setting B application condition in accordance with Embodiment 2, the frequency defining section 102a in accordance with Variation 1 adds a first predetermined value to a CPU frequency defined based on the frequency setting A and the CPU load determined by the processing load determining section 103. Further, in a case where the smartphone 1a satisfies any of the conditions of the setting C application condition in accordance with Embodiment 2, the frequency defining section 102a adds a second predetermined value, which is different from the first predetermined value, to a CPU frequency defined based on the frequency setting A and the CPU load determined by the processing load determining section 103. Then, the frequency defining section 102a defines the CPU frequency of the CPU 12 as a value obtained by the addition. Note that the first predetermined value is greater than the second predetermined value.

Thus, the smartphone 1a in accordance with Variation 1 can implement the same functions as in a case where each of the frequency settings described in Embodiment 2 is applied to the smartphone 1a. For example, in a case where communication throughput increases, the smartphone 1a can ensure the processing capacity of the CPU 12 for carrying out communication processing. In a situation where the communication throughput is medium, the smartphone 1a can ensure an appropriate processing capability of a CPU. Thus, the smartphone 1a in accordance with Variation 1 can ensure an appropriate processing capacity of a CPU by adding a value appropriate to a situation to a CPU frequency.

[Variation 2]

An aspect of the present invention may be a combined configuration of the configuration described in Embodiment 3 and the configuration described in Embodiment 4. For example, the frequency defining section 102a in accordance with Variation 2 has not only the function described in Variation 1 but also a function described below.

That is, in a case where the smartphone 1a satisfies a condition indicating that a communication time of the smartphone 1a is long or is going to be long, the frequency defining section 102a defines the CPU frequency as a CPU frequency which is obtained by subtracting a predetermined value from a CPU frequency brought into correspondence with a determined CPU load in the frequency setting A.

That is, in a case where the smartphone 1a satisfies any of the conditions of the setting D application condition in accordance with Embodiment 3, the frequency defining section 102a subtracts a third predetermined value from a CPU frequency defined based on the frequency setting A and the CPU load determined by the processing load determining section 103. Then, the frequency defining section 102a defines the CPU frequency of the CPU 12 as a value obtained by the subtraction. Note that the third predetermined value may be equal to the first predetermined value or the second predetermined value or may be different from the first predetermined value or the second predetermined value.

Further, in a case where the smartphone 1a satisfies none of the application conditions in accordance with Embodiment 3, the frequency setting applying section 101 in accordance with Variation 2 does not carry out addition of a predetermined value to a current CPU frequency or subtraction of a predetermined value from a current CPU frequency.

Thus, the smartphone 1a in accordance with Variation 2 can implement the same functions as in a case where each of the frequency settings described in Embodiment 3 is applied to the smartphone 1a. For example, in a case where communication throughput increases, the smartphone 1a can ensure the processing capacity of the CPU 12 for carrying out communication processing. In a case where the smartphone 1a carries out communication for a prolonged period of time, the smartphone 1a can limit a CPU frequency against a CPU load. Thus, the smartphone 1a in accordance with Variation 2 can prevent a decreased processing capacity of a CPU by adding a value appropriate to a situation to a CPU frequency or by subtracting a value appropriate to a situation from a CPU frequency.

[Variation 3]

An aspect of the present invention may be a combined configuration of the configuration described in Embodiment 3 and the configuration described in Embodiment 5. For example, the frequency setting 111 in accordance with Variation 3 may contain the frequency setting D in accordance with Embodiment 3. Further, the setting D application condition in accordance with Variation 3 may be the setting A application condition in accordance with Embodiment 5.

In a case where the smartphone 1b satisfies any of the conditions of the setting D application condition, the frequency setting applying section 101 in accordance with Variation 3 applies the frequency setting D to the smartphone 1b. This allows the smartphone 1b in accordance with Variation 3 to limit a CPU frequency against a CPU load, as compared to a case where the frequency setting A is applied to the smartphone 1b. This allows the smartphone 1b to further reduce heat generated by the CPU 12 due to communications over a prolonged period of time. Thus, the smartphone 1b can further prevent the processing capacity of the CPU 12 from being decreased due to heat generation.

Note that in Variation 3, the setting A application condition is not set. Only in a case where the smartphone 1b does not satisfy any of the application conditions, the frequency setting applying section 101 in accordance with Variation 3 applies the frequency setting A to the smartphone 1b.

[Variation 4]

An aspect of the present invention may be a combined configuration of the configuration described in Embodiment 4 and the configuration described in Embodiment 5. For example, in a case where a smartphone satisfies the addition condition, the frequency defining section 102 in accordance with Variation 4, like the frequency defining section 102a in accordance with Embodiment 4, may add a predetermined value to a current CPU frequency. Then, the frequency defining section 102 in accordance with Variation 4 may define the CPU frequency as a new CPU frequency obtained by the addition. Here, the addition condition may be the setting B application condition described in Embodiment 5. Specifically, the addition condition may be a condition that a smartphone is in communication.

[Software Implementation Example]

Control blocks of the smartphones 1, 1a, and 1b (particularly, the CPU control section 10) can be realized by a logic circuit (hardware) provided in an integrated circuit (IC chip) or the like or can be alternatively realized by software with use of a central processing unit (CPU).

In the latter case, the smartphones 1, 1a, and 1b each include, for example, a CPU that executes instructions of a program that is software realizing the foregoing functions; a read only memory (ROM) or a storage device (each referred to as “storage medium”) in which the program and various kinds of data are stored so as to be readable by a computer (or the CPU); and a random access memory (RAM) in which the program is loaded. An object of the present invention can be achieved by the computer (or the CPU) reading and executing the program stored in the storage medium. Examples of the storage medium encompass “a non-transitory tangible medium” including, for example, a tape, a disk, a card, a semiconductor memory, and a programmable logic circuit. The program can be made available to the computer via any transmission medium (such as a communication network or a broadcast wave) which allows the program to be transmitted. Note that an aspect of the present invention can also be achieved in the form of a computer data signal in which the program is embodied via electronic transmission and which is embedded in a carrier wave.

[Recap]

An information processing device (smartphone 1, smartphone 1a) in accordance with a first aspect of the present invention is an information processing device having a CPU (CPU 12) which is capable of carrying out processing for communication with an external device, the information processing device including: a storage section (storage section 11) configured to store first frequency setting information which is referred to at start-up of the information processing device, the first frequency setting information containing a processing load of the CPU and an operating frequency of the CPU both of which are brought into correspondence with each other; and a defining section (frequency defining section 102, frequency defining section 102a) configured to, in a case where a current value of communication throughput is equal to or greater than a first reference value or in a case where an expected value of the communication throughput is equal to or greater than a second reference value, define an operating frequency of the CPU as a value equal to or greater than an operating frequency brought into correspondence with a current processing load in the first frequency setting information.

According to the above configuration, the defining section is configured to, in a case where a current value of communication throughput is equal to or greater than a first reference value or in a case where an expected value of the communication throughput is equal to or greater than a second reference value, define an operating frequency of the CPU as an operating frequency equal to or greater than an operating frequency brought into correspondence with a current processing load in the first frequency setting information. This allows the information processing device to ensure, in advance, the processing capacity of the CPU for carrying out communication processing in a situation where the information processing device is required to provide a high communication throughput. Thus, even when the processing load is abruptly increased, the information processing device can carry out communication processing without decreasing the communication throughput. Therefore, the information processing device can carry out communication processing without impairing the comfort of a user.

Note that the first reference value is a numerical value to be compared with a current value of communication throughput. Further, the second reference value is a numerical value to be compared with an expected value of communication throughput. The first reference value and the second reference value may be equal to each other or may be different from each other.

In a second aspect of the present invention, the information processing device (smartphone 1) may be arranged such that, in the first aspect of the present invention, the storage section further stores second frequency setting information containing a processing load of the CPU and an operating frequency of the CPU both of which are brought into correspondence with each other and indicating that the operating frequency is equal to or greater than the operating frequency in the first frequency setting information under a condition in which the CPU load in the first frequency setting information is equal to the CPU load in the second frequency setting information, and in a case where the current value of the communication throughput is equal to or greater than the first reference value or in a case where the expected value of the communication throughput is equal to or greater than the second reference value, the defining section (frequency defining section 102) defines an operating frequency of the CPU as an operating frequency brought into correspondence with a current processing load in the second frequency setting information.

According to the above configuration, the defining section is configured to, in a case where a current value of communication throughput is equal to or greater than a first reference value or in a case where an expected value of the communication throughput is equal to or greater than a second reference value, refer to the second frequency setting information to define an operating frequency of the CPU, the second frequency setting information specifying in advance an operating frequency equal to or greater than an operating frequency brought into correspondence in the first frequency setting information. This allows the information processing device to carry out communication processing without impairing the comfort of a user, with a simple configuration in which a plurality of pieces of frequency setting information are stored.

In a third aspect of the present invention, the information processing device (smartphone 1a) may be arranged such that, in the first aspect of the present invention, in a case where the current value of the communication throughput is equal to or greater than the first reference value or in a case where the expected value of the communication throughput is equal to or greater than a second reference value, the defining section (frequency defining section 102a) defines an operating frequency of the CPU as an operating frequency obtained by adding a predetermined value to an operating frequency brought into correspondence with a current processing load in the first frequency setting information.

According to the above configuration, the defining section is configured to, in a case where a current value of communication throughput is equal to or greater than a first reference value or in a case where an expected value of the communication throughput is equal to or greater than a second reference value, define an operating frequency of the CPU as an operating frequency obtained by adding a predetermined value to an operating frequency brought into correspondence in the first frequency setting information. This allows the information processing device to carry out communication processing without impairing the comfort of a user, simply by storing the first frequency setting information. This also allows the information processing device to reduce the amount of data to be stored in the storage section. Further, implementation of the information processing device can be simplified.

An information processing device (smartphone 1b) in accordance with a fourth aspect of the present invention is an information processing device having a CPU (CPU 12) which is capable of carrying out processing for communication with an external device, the information processing device including: a storage section (storage section 11b) configured to store first frequency setting information which is referred to at start-up of the information processing device, the first frequency setting information containing a processing load of the CPU and an operating frequency of the CPU both of which are brought into correspondence with each other; and a defining section (frequency defining section 102) configured to, in a case where the information processing device is in communication, define an operating frequency of the CPU as a value equal to or greater than an operating frequency brought into correspondence with a current processing load in the first frequency setting information.

According to the above configuration, the defining section is configured to, in a case where the information processing device is in communication, define an operating frequency as an operating frequency equal to or greater than an operating frequency brought into correspondence with a current processing load in the first frequency setting information. This allows the information processing device to ensure, in advance, the processing capacity of the CPU for carrying out communication processing. Thus, even when the processing load is abruptly increased, the information processing device can carry out communication processing without decreasing the communication throughput. Therefore, the information processing device can carry out communication processing without impairing the comfort of a user. Further, the information processing device can determine whether to increase an operating frequency by making a simple determination as to whether the information processing device is in communication.

In a fifth aspect of the present invention, the information processing device may be arranged such that, in the fourth aspect of the present invention, the storage section further stores second frequency setting information containing a processing load of the CPU and an operating frequency of the CPU both of which are brought into correspondence with each other and indicating that the operating frequency is equal to or greater than the operating frequency in the first frequency setting information under a condition in which the CPU load in the first frequency setting information is equal to the CPU load in the second frequency setting information, and in a case where the information processing device is in communication, the defining section defines an operating frequency of the CPU as an operating frequency brought into correspondence with a current processing load in the second frequency setting information.

According to the above configuration, the defining section is configured to, in a case where the information processing device is in communication, refer to the second frequency setting information to define an operating frequency of the CPU, the second frequency setting information specifying in advance an operating frequency equal to or greater than an operating frequency brought into correspondence in the first frequency setting information. This allows the information processing device to carry out communication processing without impairing the comfort of a user, with a simple configuration in which a plurality of pieces of frequency setting information are stored.

In a sixth aspect of the present invention, the information processing device may be arranged such that, in the fourth aspect of the present invention, in a case where the information processing device is in communication, the defining section defines an operating frequency of the CPU as an operating frequency obtained by adding a predetermined value to an operating frequency brought into correspondence with a current processing load in the first frequency setting information.

According to the above configuration, the defining section is configured to, in a case where the information processing device is in communication, define an operating frequency of the CPU as an operating frequency obtained by adding a predetermined value to an operating frequency brought into correspondence in the first frequency setting information. This allows the information processing device to carry out communication processing without impairing the comfort of a user, simply by storing the first frequency setting information. This also allows the information processing device to reduce the amount of data to be stored in the storage section. Further, implementation of the information processing device can be simplified.

In a seventh aspect of the present invention, the information processing device may be arranged such that, in any one of the first to sixth aspects of the present invention, in a case where a total communication time between start of communication with the external device and a current time is greater than a third reference value or in a case where an expected communication time between the start of communication with the external device and end of the communication with the external device is equal to or greater than a fourth reference value, the defining section defines an operating frequency of the CPU as an operating frequency brought into correspondence with a current processing load in the first frequency setting information, instead of defining the operating frequency of the CPU as a value equal to or greater than the operating frequency brought into correspondence with the current processing load in the first frequency setting information.

According to the above configuration, in a case where the total communication time is greater than the third reference value or in a case where the expected communication time is equal to or greater than the fourth reference value, the defining section does not define an operating frequency of the CPU as an operating frequency which is greater than an operating frequency based on the first frequency setting information. This allows the information processing device to reduce power consumption in a situation where communication is carried out over a prolonged period of time. Thus, the information processing device can prevent increased temperature of the CPU. Consequently, the information processing device can prevent decreased performance of the CPU. Therefore, the information processing device can provide stable communication throughput and stable performance of the CPU.

Note that the third reference value is a numerical value to be compared with the total communication time. Further, the fourth reference value is a numerical value to be compared with the expected communication time. The third reference value and the fourth reference value may be equal to each other or may be different from each other.

In an eighth aspect of the present invention, the information processing device may be arranged such that, in any one of the first to sixth aspects of the present invention, in a case where a total communication time between start of communication with the external device and a current time is greater than a third reference value or in a case where an expected communication time between the start of communication with the external device and end of the communication with the external device is equal to or greater than a fourth reference value, the defining section defines an operating frequency of the CPU as an operating frequency equal to or less than an operating frequency brought into correspondence with a current processing load in the first frequency setting information, instead of defining the operating frequency of the CPU as a value equal to or greater than the operating frequency brought into correspondence with the current processing load in the first frequency setting information.

According to the above configuration, in a case where the total communication time is greater than the third reference value or in a case where the expected communication time is equal to or greater than the fourth reference value, the defining section defines an operating frequency of the CPU as an operating frequency which is less than an operating frequency based on the first frequency setting information. This allows the information processing device to further reduce power consumption in a situation where communication is carried out over a prolonged period of time. Thus, the information processing device can further prevent increased temperature of the CPU. Consequently, the information processing device can further prevent decreased performance of the CPU.

In a ninth aspect of the present invention, the information processing device may be arranged such that, in the eighth aspect of the present invention, the storage section further stores third frequency setting information containing a processing load of the CPU and an operating frequency of the CPU both of which are brought into correspondence with each other and indicating that the operating frequency is equal to or less than the operating frequency in the first frequency setting information under a condition in which a processing load in the first frequency setting information is equal to a processing load in the third frequency setting information, and in a case where the total communication time is greater than the third reference value or in a case where the expected communication time is equal to or greater than the fourth reference value, the defining section defines an operating frequency of the CPU as an operating frequency brought into correspondence with a current processing load in the third frequency setting information.

According to the above configuration, the defining section is configured to, in a case where the total communication time is greater than the third reference value or in a case where the expected communication time is equal to or greater than the fourth reference value, refer to the third frequency setting information to define an operating frequency of the CPU, the third frequency setting information specifying in advance an operating frequency equal to or less than an operating frequency brought into correspondence in the first frequency setting information. This allows the information processing device to prevent decreased performance of the CPU caused by increased temperature of the CPU, with a simple configuration in which a plurality of pieces of frequency setting information are stored.

In a tenth aspect of the present invention, the information processing device may be arranged such that, in the eighth aspect of the present invention, in a case where the total communication time is greater than the third reference value or in a case where the expected communication time is equal to or greater than the fourth reference value, the defining section defines an operating frequency of the CPU as an operating frequency obtained by subtracting a predetermined value from an operating frequency brought into correspondence with a current processing load in the first frequency setting information.

According to the above configuration, the defining section is configured to, in a case where the total communication time is greater than the third reference value or in a case where the expected communication time is equal to or greater than the fourth reference value, define an operating frequency of the CPU by subtracting a predetermined value from an operating frequency brought into correspondence in the first frequency setting information. This allows the information processing device to prevent decreased performance of the CPU caused by increased temperature of the CPU, simply by storing the first frequency setting information. This also allows the information processing device to reduce the amount of data to be stored in the storage section. Further, implementation of the information processing device can be simplified.

A method of controlling an information processing device in accordance with an eleventh aspect of the present invention is a method of controlling an information processing device having a CPU which is capable of carrying out processing for communication with an external device, the information processing device including a storage section configured to store first frequency setting information which is referred to at start-up of the information processing device, the first frequency setting information containing a processing load of the CPU and an operating frequency of the CPU both of which are brought into correspondence with each other, the method including a defining step (step S8) of, in a case where a current value of communication throughput is equal to or greater than a first reference value or in a case where an expected value of the communication throughput is equal to or greater than a second reference value, defining an operating frequency of the CPU as a value equal to or greater than an operating frequency brought into correspondence with a current processing load in the first frequency setting information.

According to the above configuration, a method of controlling an information processing device in accordance with the eleventh aspect yields an operational effect similar to that yielded by the information processing device in accordance with the first aspect.

A method of controlling an information processing device in accordance with a twelfth aspect of the present invention is a method of controlling an information processing device having a CPU which is capable of carrying out processing for communication with an external device,

the information processing device including a storage section configured to store first frequency setting information which is referred to at start-up of the information processing device, the first frequency setting information containing a processing load of the CPU and an operating frequency of the CPU both of which are brought into correspondence with each other, the method including a defining step (step S66) of, in a case where the information processing device is in communication, defining an operating frequency of the CPU as a value equal to or greater than an operating frequency brought into correspondence with a current processing load in the first frequency setting information.

According to the above configuration, a method of controlling an information processing device in accordance with the twelfth aspect yields an operational effect similar to that yielded by the information processing device in accordance with the fourth aspect.

An information processing device in accordance with the foregoing aspects of the present invention may be realized by a computer. In this case, the present invention encompasses: a control program for the information processing device which program causes a computer to operate as the foregoing sections (software elements) of the information processing device so that the information processing device can be realized by the computer; and a computer-readable storage medium storing the control program therein.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

1, 1a, 1b: Smartphone (information processing device); 11, 11b: Storage section; 12: CPU; 102, 102a: Frequency defining section (defining section); S8, S66: Defining step

1. An information processing device having a CPU which is capable of carrying out processing for communication with an external device, the information processing device comprising:
a storage section configured to store first frequency setting information which is referred to at start-up of the information processing device, the first frequency setting information containing a processing load of the CPU and an operating frequency of the CPU both of which are brought into correspondence with each other; and
a defining section configured to, in a case where a current value of communication throughput is equal to or greater than a first reference value or in a case where an expected value of the communication throughput is equal to or greater than a second reference value, define an operating frequency of the CPU as a value equal to or greater than an operating frequency brought into correspondence with a current processing load in the first frequency setting information.

2. The information processing device according to claim 1, wherein the storage section further stores second frequency setting information containing a processing load of the CPU and an operating frequency of the CPU both of which are brought into correspondence with each other and indicating that the operating frequency is equal to or greater than the operating frequency in the first frequency setting information under a condition in which the CPU load in the first frequency setting information is equal to the CPU load in the second frequency setting information, and
in a case where the current value of the communication throughput is equal to or greater than the first reference value or in a case where the expected value of the communication throughput is equal to or greater than the second reference value, the defining section defines an operating frequency of the CPU as an operating frequency brought into correspondence with a current processing load in the second frequency setting information.

3. The information processing device according to claim 1, wherein in a case where the current value of the communication throughput is equal to or greater than the first reference value or in a case where the expected value of the communication throughput is equal to or greater than a second reference value, the defining section defines an operating frequency of the CPU as an operating frequency obtained by adding a predetermined value to an operating frequency brought into correspondence with a current processing load in the first frequency setting information.

4. An information processing device having a CPU which is capable of carrying out processing for communication with an external device, the information processing device comprising:
a storage section configured to store first frequency setting information which is referred to at start-up of the information processing device, the first frequency setting information containing a processing load of the CPU and an operating frequency of the CPU both of which are brought into correspondence with each other; and
a defining section configured to, in a case where the information processing device is in communication, define an operating frequency of the CPU as a value equal to or greater than an operating frequency brought into correspondence with a current processing load in the first frequency setting information.

5. The information processing device according to claim 4, wherein the storage section further stores second frequency setting information containing a processing load of the CPU and an operating frequency of the CPU both of which are brought into correspondence with each other and indicating that the operating frequency is equal to or greater than the operating frequency in the first frequency setting information under a condition in which the CPU load in the first frequency setting information is equal to the CPU load in the second frequency setting information, and
in a case where the information processing device is in communication, the defining section defines an operating frequency of the CPU as an operating frequency brought into correspondence with a current processing load in the second frequency setting information.

6. The information processing device according to claim 4, wherein in a case where the information processing device is in communication, the defining section defines an operating frequency of the CPU as an operating frequency obtained by adding a predetermined value to an operating frequency brought into correspondence with a current processing load in the first frequency setting information.

7. The information processing device according to claim 1, wherein in a case where a total communication time between start of communication with the external device and a current time is greater than a third reference value or in a case where an expected communication time between the start of communication with the external device and end of the communication with the external device is equal to or greater than a fourth reference value, the defining section defines an operating frequency of the CPU as an operating frequency brought into correspondence with a current processing load in the first frequency setting information, instead of defining the operating frequency of the CPU as a value equal to or greater than the operating frequency brought into correspondence with the current processing load in the first frequency setting information.

8. The information processing device according to claim 1, wherein in a case where a total communication time between start of communication with the external device and a current time is greater than a third reference value or in a case where an expected communication time between the start of communication with the external device and end of the communication with the external device is equal to or greater than a fourth reference value, the defining section defines an operating frequency of the CPU as an operating frequency equal to or less than an operating frequency brought into correspondence with a current processing load in the first frequency setting information, instead of defining the operating frequency of the CPU as a value equal to or greater than the operating frequency brought into correspondence with the current processing load in the first frequency setting information.

9. The information processing device according to claim 8, wherein the storage section further stores third frequency setting information containing a processing load of the CPU and an operating frequency of the CPU both of which are brought into correspondence with each other and indicating that the operating frequency is equal to or less than the operating frequency in the first frequency setting information under a condition in which a processing load in the first frequency setting information is equal to a processing load in the third frequency setting information, and
in a case where the total communication time is greater than the third reference value or in a case where the expected communication time is equal to or greater than the fourth reference value, the defining section defines an operating frequency of the CPU as an operating frequency brought into correspondence with a current processing load in the third frequency setting information.

10. The information processing device according to claim 8, wherein in a case where the total communication time is greater than the third reference value or in a case where the expected communication time is equal to or greater than the fourth reference value, the defining section defines an operating frequency of the CPU as an operating frequency obtained by subtracting a predetermined value from an operating frequency brought into correspondence with a current processing load in the first frequency setting information.

11. A method of controlling an information processing device having a CPU which is capable of carrying out processing for communication with an external device,
the information processing device comprising a storage section configured to store first frequency setting information which is referred to at start-up of the information processing device, the first frequency setting information containing a processing load of the CPU and an operating frequency of the CPU both of which are brought into correspondence with each other,
the method comprising:
a determining step of determining a current processing load; and
a defining step of, in a case where a current value of communication throughput is equal to or greater than a first reference value or in a case where an expected value of the communication throughput is equal to or greater than a second reference value, defining an operating frequency of the CPU as a value equal to or greater than an operating frequency brought into correspondence with the current processing load in the first frequency setting information.

12. A method of controlling an information processing device having a CPU which is capable of carrying out processing for communication with an external device,
the information processing device comprising a storage section configured to store first frequency setting information which is referred to at start-up of the information processing device, the first frequency setting information containing a processing load of the CPU and an operating frequency of the CPU both of which are brought into correspondence with each other,
the method comprising:
a determining step of determining a current processing load; and
a defining step of, in a case where the information processing device is in communication, defining an operating frequency of the CPU as a value equal to or greater than an operating frequency brought into correspondence with the current processing load in the first frequency setting information.

13. (canceled)

14. A non-transitory computer-readable storage medium storing a control program for causing a computer to function as an information processing device recited in claim 1, the control program causing the computer to function as the defining section.
